(19) United States
(12) Patent Application Publication
(10) Pub. No.: US 2026/0218628 A1
(43) Pub. Date: Jul. 30, 2026

(54) DUAL PASSAGE HEAT EXCHANGER FOR REDUCING COLD WALL STRESS AND METHOD THEREOF

(71) Applicant: RTX CORPORATION, Farmington, CT (US)

(72) Inventors: Cheng GAO, South Glastonbury, CT (US); Andrew S. MILLER, Marlbourough, CT (US)

(73) Assignee: RTX CORPORATION, Farmington, CT (US)

(21) Appl. No.: 19/041,080

(22) Filed: Jan. 30, 2025

(51) Int. Cl. F01D 25/12; F01D 5/28; F01D 11/08; F23R 3/00

(52) U.S. Cl. CPC F01D 25/12; F01D 5/282; F01D 11/08; F23R 3/002; F05D 2260/20

(57) ABSTRACT

A ceramic matrix composite (CMC) component of a gas turbine engine forming a portion of a substantially ring-shaped gas turbine engine stage includes an inner surface configured for exposure to a hot gas path of the gas turbine engine and an outer surface on a non-gas path side. The inner surface can be cooled with cold air fed to an inner heat exchange passage disposed adjacent the inner surface of the CMC component at a first radial distance relative to an axis of the gas turbine engine. Thermal stress at the cold outer surface can be reduced by feeding hot air to an outer heat exchange passage disposed adjacent the outer surface at a second radial distance greater than the first radial distance.

### FIELD OF THE INVENTION

The subject matter disclosed herein relates to a heat exchange passage to lower thermal stress and, in particular, to a dual passage heat exchanger for reducing thermal stress on ceramic matrix composite (CMC) component in a gas turbine engine.

### BACKGROUND OF THE INVENTION

Gas turbine engines or jet engines, in general, include a fan section, a compressor section, a combustion section, and a turbine section. Air enters through the fan section and is compressed in the compressor section before being introduced into the combustion section. In the combustion section, the air is mixed with fuel and ignited to generate a high-energy, high temperature gas flow. The high-energy, high temperature gas flow is expanded in the turbine section which is used to create thrust and to drive the compressor and fan sections.

Certain components of gas turbine engines are thus exposed to the high-energy, high temperature gas flow (flow path components). Therefore, it is desirable that such components be made of heat-resistant materials such as ceramic matrix composites (CMCs). CMC components can withstand much higher operating temperatures than components composed of superalloys. However, CMC components have comparably lower thermal conductivity. To increase their operational lifespans, precautions can be taken to cool CMC components by supplying a flow of cooling fluid (e.g., air) for heat exchange and/or film cooling of portions of the CMC component exposed to the high temperature gas flow.

To provide this cooling of CMC components, secondary air flows, i.e., secondary to the main flow of high-energy, high temperature gas, can be used to cool components of the gas turbine engines that are exposed to high temperatures as well as to prevent high temperature gas from reaching those components that are not directly exposed to the hot gas flow. To facilitate the cooling of the CMC components, passages can be provided within the components themselves to allow secondary cooling air to flow from one region to another region of the turbine. For example, a component such as a blade outer air seal (BOAS, sometimes referred to as a blade shroud) can be provided with an internal passage to allow cooling air to flow to a region between the engine casing and the outer radial surface of the BOAS into the internal cooling passage of the BOAS to cool the interior of the component and thereby reduce its thermal deterioration due to exposure to the hot gas path.

Internal cooling passage features such as skins cores are desired because they provide an enhanced cooling capability. Multiple processes have been identified to manufacture internal cores on CMC components, either during preforming/layup process, or post-densification from burnout of fugitive material used during layup (e.g. graphite filler).

However, a remaining challenge in CMC component design with subsurface cooling cores/passages is the high thermal stress driven by thermal differences between the hot wall of the gas path surface and the cold wall of the non-gas path surface.

The above information disclosed in this Background section is only for understanding of the background of the inventive concepts and, therefore, it may contain information that does not constitute prior art.

### SUMMARY OF THE INVENTION

The present disclosure is directed, in a first aspect, to a ceramic matrix composite (CMC) component of a gas turbine engine that forms a portion of a substantially ring-shaped gas turbine engine stage. The CMC component includes: an inner surface configured for exposure to a hot gas path of the gas turbine engine; an outer surface on a non-gas path side; an inner heat exchange passage disposed adjacent the inner surface of the CMC component at a first radial distance relative to an axis of the gas turbine engine; and an outer heat exchange passage disposed at a second radial distance greater than the first radial distance.

In an embodiment of the CMC component, the outer heat exchange passage is disposed adjacent the outer surface.

In another embodiment of the CMC component, the CMC component includes a mateface transversely disposed between the inner surface and the outer surface, and an outlet of the outer heat exchange passage and/or the inner heat exchange passage may be disposed on the mateface.

In a further embodiment of the CMC component, a first cold air inlet and a second cold air inlet may be disposed on the outer surface, the first cold air inlet may feed a first inner heat exchange passage that extends towards a leading edge of the CMC component and feed a first plurality of film cooling holes that extend to the inner surface of the CMC component, and the second cold air inlet may feed a second inner heat exchange passage that extends to a trailing edge of the CMC component and feed a second plurality of film cooling holes that extend to the inner surface of the CMC component.

In yet another embodiment of the CMC component, a hot air inlet of the outer heat exchange passage may be disposed on a leading edge of the CMC component or on the inner surface of the CMC component to receive air from the hot gas path.

In an embodiment of the CMC component, the inner heat exchange passage may feed a plurality of film cooling holes disposed on the inner surface of the CMC component.

In another embodiment of the CMC component, at least one of the inner heat exchange passage and the outer heat exchange passage may have an exit on a trailing edge of the CMC component.

In a further embodiment of the CMC component, the inner heat exchange passage may include a plurality of inner heat exchange passages that each extend from a cold air inlet at a leading edge side of the outer surface to a cold air outlet at a trailing edge of the CMC component, and the outer heat exchange passage may includes a hot air inlet at a trailing edge side of the outer surface, a pass from the hot air inlet in counterflow with one of the inner heat exchange passages, a pass in parallel flow with another of the inner heat exchange passages, and a hot air outlet at the trailing edge of the CMC component.

In an embodiment of the CMC component, the CMC component may be a blade outer air seal (BOAS), a vane platform, or a combustion liner.

The present disclosure is also directed, in a second aspect, to a ceramic matrix composite (CMC) blade outer air seal (BOAS) segment forming a portion of a substantially ring-shaped BOAS stage of a gas turbine engine. The CMC BOAS segment includes: an inner surface configured for exposure to a hot gas path of the gas turbine engine; an outer surface on a non-gas path side; an inner heat exchange passage disposed adjacent the inner surface of the CMC BOAS segment at a first radial distance relative to an axis of the gas turbine engine; and an outer heat exchange passage disposed adjacent the outer surface of the CMC BOAS segment at a second radial distance greater than the first radial distance.

In an embodiment, the CMC BOAS segment may include a mateface transversely disposed between the inner surface and the outer surface, and an outlet of the outer heat exchange passage and/or the inner heat exchange passage may be disposed on the mateface.

In another embodiment of the CMC BOAS segment, a hot air inlet of the outer heat exchange passage may be disposed on a leading edge of the CMC BOAS segment or on the inner surface of the CMC BOAS segment to receive air from the hot gas path, the inner heat exchange passage may feed a plurality of film cooling holes disposed on the inner surface of the CMC BOAS segment, and at least one of the inner heat exchange passage and the outer heat exchange passage may have an exit on a trailing edge of the CMC BOAS segment.

In a further embodiment of the CMC BOAS segment, a first cold air inlet and a second cold air inlet may be disposed on the outer surface between support flanges of the CMC BOAS segment, the first cold air inlet may feed a first inner heat exchange passage that extends towards a leading edge of the CMC BOAS segment and feed a first plurality of film cooling holes that extend to the inner surface of the CMC BOAS segment, and the second cold air inlet may feed a second inner heat exchange passage that extends to a trailing edge of the CMC BOAS segment and feed a second plurality of film cooling holes that extend to the inner surface of the CMC BOAS segment.

The present disclosure is further directed, in a third aspect, to a method of reducing thermal stress in a ceramic matrix composite (CMC) component segment forming a portion of a substantially ring-shaped stage of a gas turbine engine, wherein the CMC component has an inner surface exposed to a hot gas path of the gas turbine engine and an outer surface on a cold non-gas path side. The method includes feeding a cold air flow to an inner heat exchange passage disposed adjacent the inner surface of the CMC component at a first radial distance relative to an axis of the gas turbine engine; and feeding a hot air flow to an outer heat exchange passage disposed adjacent the outer surface of the CMC component at a second radial distance greater than the first radial distance.

An embodiment of the method may further include feeding the hot air flow and/or the cold air flow to a respective outlet of the outer heat exchange passage and/or the inner heat exchange passage disposed on the mateface and/or the trailing edge.

In another embodiment of the method, feeding the hot air flow to the outer heat exchange passage may include receiving engine gas path air at a hot air inlet of the outer heat exchange passage.

In a further embodiment of the method, feeding the cold air flow to the inner heat exchange passage may include receiving cold air at a cold air inlet of the inner heat exchange passage disposed on the outer surface of the CMC component.

In yet another embodiment, the method may further include providing film cooling to the inner surface of the CMC component via film cooling holes in communication with the inner heat exchange passage.

In an embodiment, the method may further include exchanging heat between the inner heat exchange passage and the outer heat exchange passage.

In yet another embodiment of the method, the CMC component may be a blade outer air seal (BOAS) segment, a vane platform segment, or a combustion liner segment.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 schematically illustrates a partial cross section of an exemplary gas turbine engine;

FIG. 2A schematically illustrates a cross sectional elevation view of an example embodiment of CMC component in accordance with the present disclosure;

FIG. 2B schematically illustrates a perspective view of another example embodiment of CMC component in accordance with the present disclosure;

FIG. 2C schematically illustrates a perspective view of a further example embodiment of CMC component in accordance with the present disclosure;

FIG. 2D schematically illustrates a cross sectional top view of an outer heat exchange passage in an example embodiment of CMC component in accordance with the present disclosure;

FIG. 2E schematically illustrates a cross sectional view of an inner heat exchange passage in an example embodiment of CMC component in accordance with the present disclosure;

FIG. 2F schematically illustrates a cross sectional view of another example embodiment of CMC component in accordance with the present disclosure;

FIG. 2G schematically illustrates a perspective view of a further example embodiment of CMC component in accordance with the present disclosure; and

FIG. 3 is a flow diagram of an example method in accordance with the present disclosure.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

The following discussion omits or only briefly describes conventional features of the disclosed technology that are apparent to those skilled in the art. Reference to a particular embodiment does not limit the scope of the claims attached hereto. Additionally, any examples set forth in this specification are intended to be non-limiting and merely set forth some of the many possible embodiments for the appended claims. Further, particular features described herein can be used in combination with other described features in each of the various possible combinations and permutations. A person of ordinary skill in the art would know how to use the instant invention, in combination with routine experiments, to achieve other outcomes not specifically disclosed in the examples or the embodiments.

Unless otherwise specifically defined herein, all terms are to be given their broadest possible interpretation including meanings implied from the specification as well as meanings understood by those skilled in the art and/or as defined in dictionaries, treatises, etc. Unless defined otherwise, all technical and scientific terms used herein have the same meaning as commonly understood by one of ordinary skill in the art in the field of the disclosed technology. It must also be noted that, as used in the specification and the appended claims, the singular forms “a,” “an,” and “the” include plural referents unless otherwise specified, and that the terms "includes" and/or "including," when used in this specification, specify the presence of stated features, elements, and/or components, but do not preclude the presence or addition of one or more other features, steps, operations, elements, components, and/or groups thereof. Additionally, methods, equipment, and materials similar or equivalent to those described herein can also be used in the practice or testing of the disclosed technology.

The devices of the present disclosure may be understood more readily by reference to the following detailed description of the embodiments taken in connection with the accompanying drawing figures, which form a part of this disclosure. It is to be understood that this application is not limited to the specific devices, methods, conditions or parameters described and/or shown herein, and that the terminology used herein is for the purpose of describing particular embodiments by way of example only and is not intended to be limiting. All spatial references, such as, for example, proximal, distal, horizontal, vertical, top, upper, lower, bottom, left and right, are for illustrative purposes only and can be varied within the scope of the disclosure. For example, the references “upper” and “lower” are relative and used only in the context to the other, and are not necessarily “superior” and “inferior.”

It will further be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

Various examples of the disclosed technology are provided throughout this disclosure. The use of these examples is illustrative only, and in no way limits the scope and meaning of the invention or of any exemplified form. Likewise, the invention is not limited to any particular preferred embodiment(s) described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

As discussed in the Background above, high tensile stress driven by thermal differences between the hot wall of the gas path surface and cold wall of the non-gas path surface may be exacerbated by the low thermal conductivity within the CMC material and may affect a lifespan of the component.

Accordingly, embodiments in accordance with the present disclosure are configured to reduce tensile stress within a CMC component that are driven by thermal differences between a hot wall and a cold wall in CMC components with internal cores/passages by utilizing radially independent passages. By utilizing internal heat exchange passages, embodiments of the present disclosure allow heat to be exchanged from higher temperature gas in one passage to lower temperature gas in another passage, thereby avoiding over-cooling the cold wall of CMC component. To achieve this, flows are separated between the different temperature passages located at different radial positions within the CMC component, with higher temperature air in an outer heat exchange passage closer to the outer non-gaspath surface, and lower temperature air in an inner heat exchange passage closer to the inner gaspath surface.

While the illustrated examples and discussion below often make reference to a blade outer air seal (BOAS) and BOAS segments, it should be recognized that the concepts of the present disclosure are not limited to BOAS segments, but rather includes any CMC component making up a ring-shaped stage of a turbine engine. Accordingly, the present disclosure is not limited to CMC BOAS segments, but may also apply to other CMC components of a gas turbine engine such as vane platforms, combustion liners, and the like where it would be desirable to avoid high thermal stress within the CMC component.

In the discussion below, axial refers to a direction that coincides with the longitudinal axis of the engine. Radial refers to a direction that is radial with respect to the longitudinal axis of the engine. Circumferential refers to a direction that corresponds to the circumference of a circle around the longitudinal axis of the engine. The leading edge/portion of a structure is the edge/portion that faces into the flow of the hot gases, i.e., faces upstream. The trailing edge/portion of a structure is the edge/portion that the faces away from the flow of the hot gases, i.e., faces downstream.

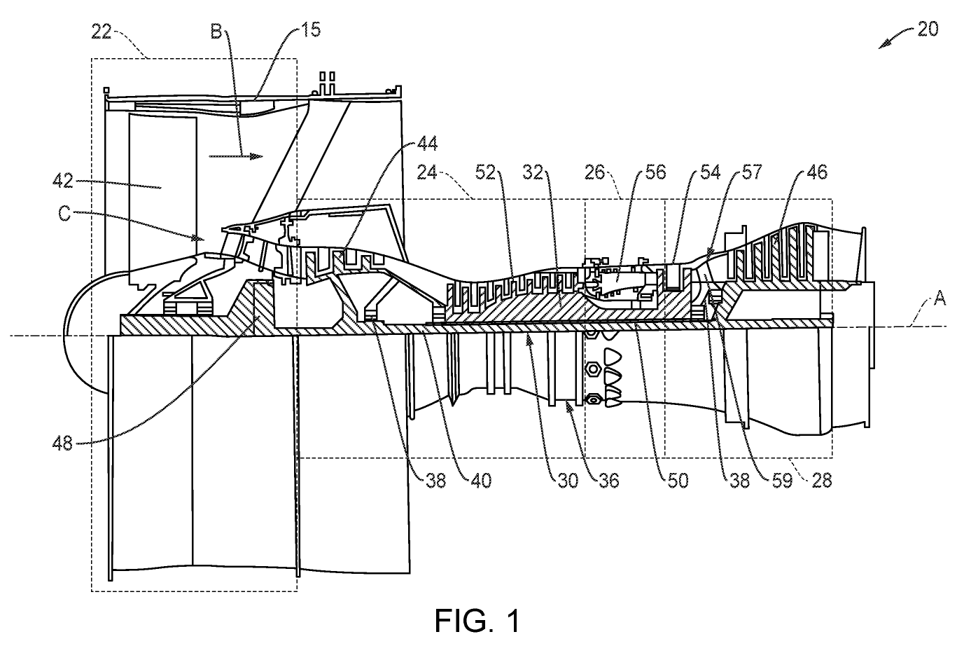

FIG. 1 schematically illustrates an example of a gas turbine engine 20 (i.e., a two-spool turbofan) which includes a fan section 22, a compressor section 24, a combustor section 26, and a turbine section 28. Fan section 22 drives air along a bypass flow path B in a bypass duct defined within a housing 15, and also along a core flow path C for compression in compressor section 24, with subsequent introduction into combustor section 26, followed by expansion through turbine section 28. Although FIG. 1 depicts a two-spool turbofan gas turbine engine, it should be understood that the concepts described herein are not limited to use with two-spool turbofans engines and may be applied to other types of turbine engines.

Engine 20 generally includes a low speed spool 30 and a high-speed spool 32 mounted for rotation about an engine central longitudinal axis A, relative to an engine static structure 36, via several bearing systems 38. Various bearing systems 38 at various locations may alternatively or additionally be provided. The location of bearing systems 38 may be varied as appropriate to the application.

The low speed spool 30 generally includes an inner shaft 40 that interconnects, a first (or low) pressure compressor 44 and a first (or low) pressure turbine 46. Inner shaft 40 is connected to fan 42 through a speed change mechanism, which in this exemplary embodiment is illustrated as a geared structure 48 to drive fan 42 at a lower speed than the low speed spool 30. High speed spool 32 includes an outer shaft 50 that interconnects a second (or high) pressure compressor 52 and a second (or high) pressure turbine 54. Combustor 56 is positioned between high pressure compressor 52 and high-pressure turbine 54. A mid-turbine frame 57 of the engine static structure 36 may be arranged generally between the high-pressure turbine 54 and the low-pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core air flow is first compressed by low pressure compressor 44, and then by the high-pressure compressor 52. Thereafter, the core air flow is mixed and burned with fuel in combustor 56, then expanded in high pressure turbine 54 and low-pressure turbine 46. The mid-turbine frame 57 includes airfoils 59 which are in the core airflow path C. The turbines 46 and 54 rotationally drive the respective low speed spool 30 and high-speed spool 32 in response to the expansion. It will be appreciated that each of the positions of the fan section 22, compressor section 24, combustor section 26, turbine section 28, and fan drive gear system 48 may be varied. For example, gear system 48 may be located aft of the low-pressure compressor, or aft of the combustor section 26 or even aft of turbine section 28, and fan 42 may be positioned forward or aft of the location of gear system 48.

The turbine section 28 includes at least one rotor and at least one blade extending radially outwardly from the rotor. The turbine section 28 may further include a blade outer air seal(s) (BOAS(s)). The blade outer air seal can be an assembly of a plurality of BOAS segments that together form an annular shaped shroud around the engine’s central longitudinal axis A which is positioned between an outer casing of the engine and the turbine blade(s) of the turbine section.

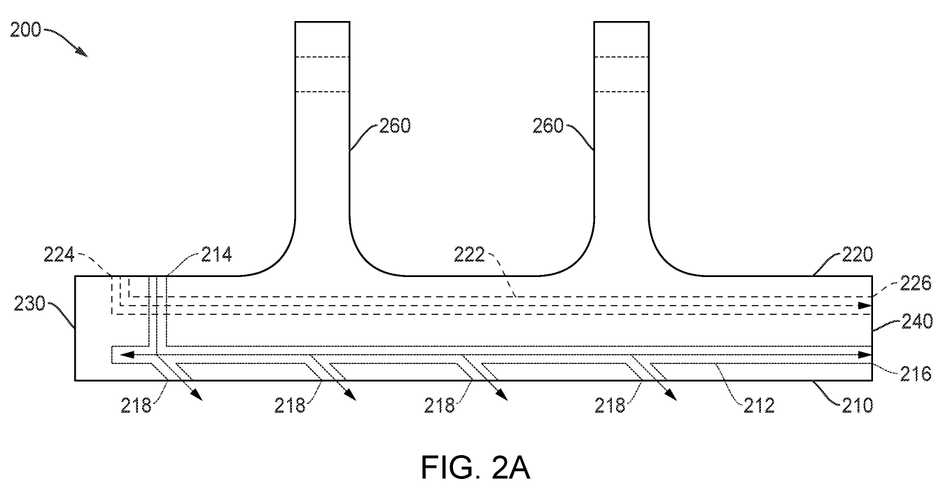

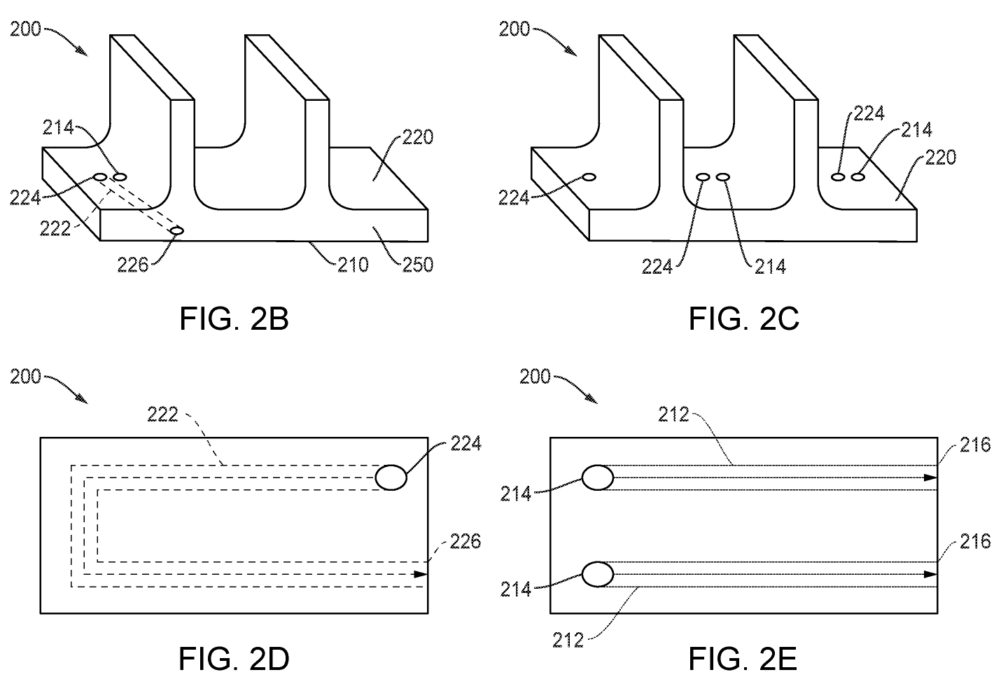

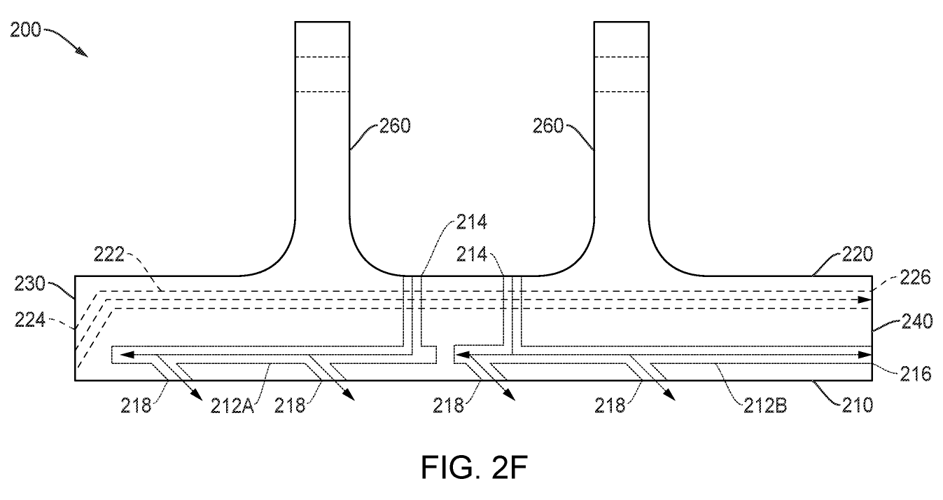

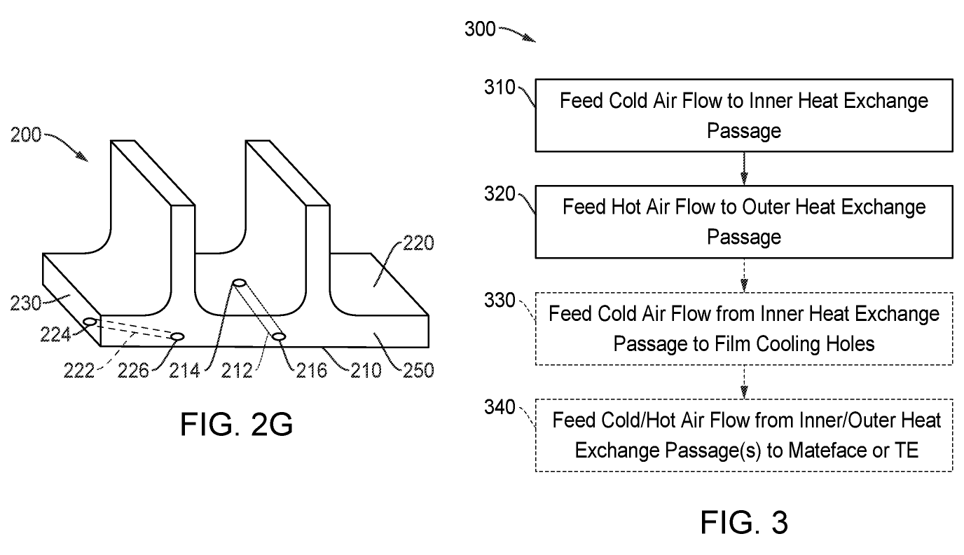

With reference to FIG. 2A, an embodiment of the present disclosure is illustrated with respect to a ceramic matrix composite (CMC) blade outer air seal (BOAS, sometimes referred to as a blade shroud) segment, hereinafter referred to generally as CMC component 200. CMC component 200 may form a portion of a substantially ring-shaped stage of a gas turbine engine. As used herein, “hot air” and “cold air” are relative terms. Hot air includes air in the range between approximately 500 to 2200 degrees Celsius, and cold air includes air in the range between approximately 200 and 900 degrees Celsius. For example, a hot air stream may be approximately 1600 degrees Celsius and a cold air stream may be approximately 500 degrees Celsius.

As part of a ring-shaped stage disposed about an axis of the gas turbine engine, the CMC component 200 has an inner surface 210 configured for exposure to a hot gas path of the gas turbine engine. The CMC component 200 further includes an outer surface 220 disposed on a non-gas path side of the CMC component. The non-gas path side 220 may have support elements such as support flanges 260 extending therefrom, such as for attachment to a support structure within the engine casing.

Embodiments of CMC component 200 in accordance with the present disclosure include an inner heat exchange passage 212 disposed adjacent the inner surface 210 of the CMC component 200 at a first radial distance relative to an axis A of the gas turbine engine (see FIG. 1) and an outer heat exchange passage 222 disposed at a second radial distance greater than the first radial distance. In an embodiment, the outer heat exchange passage 222 may be disposed adjacent the outer surface 220. A supply of cold air may be supplied to the inner heat exchange passage at cool air inlet 214, which in this embodiment is disposed in the outer surface 220 near a leading edge 230 of the CMC component. Similarly, a supply of hot air may be supplied to the outer heat exchange passage 222 at hot air inlet 224, which in this embodiment is also disposed in the outer surface 220 near a leading edge 230 of the CMC component.

In the embodiment of FIG. 2A, the inner heat exchange passage 212 feeds a plurality of film cooling holes 218 disposed on the inner surface 210 of the CMC component. The cold air flow through film cooling holes 218 may thereby form a thin film that protects the inner surface 210 from the hot gas path flow.

In the illustrated embodiment, each of the inner heat exchange passage 212 and the outer heat exchange passage 222 has an exit at cold air outlet 216 or hot air outlet 226, respectively, on a trailing edge 240 of the CMC component 200. However, embodiments in accordance with the present disclosure are not limited thereto, and inner heat exchange passage 212 and/or outer heat exchange passage 222 may direct air flow to other portions of the CMC component. For example, as illustrated in FIG. 2B, outer heat exchange passage 222 may have an exit at hot air outlet 226 on a mateface 250 that extends between inner surface 210 and outer surface 220.

Further, as illustrated in FIG. 2C, the position of cold gas inlet 214 and hot gas inlet 224 are not limited to an area near the leading edge, and may be disposed in a central area or a trailing edge area of the CMC component 200 without departing from the scope of the present disclosure.

FIGS. 2D and 2E show cross sections of an example outer heat exchange passage 222 and an associated set of inner heat exchange passages 212 that are positioned to include a pass with crossflow heat exchange and a pass with parallel heat exchange.

In FIG. 2D, hot air is provided to hot air inlet 224 near a trailing edge of CMC component 200, and a first pass of outer heat exchange passage 222 extends towards the leading edge. Outer heat exchange passage 222 extends across the leading edge end and a second pass of outer heat exchange passage 222 extends towards the trailing edge where it then exits at hot air outlet 226.

Within the same CMC component 200, the inner heat exchange passage 212 illustrated in FIG. 2E includes a plurality of inner heat exchange passages 212 that each extend from a cold air inlet 214 at a leading edge side of the outer surface to a cold air outlet 216 at a trailing edge of the CMC component. One inner heat exchange passage 212 may be located circumferentially to correspond to the first pass of the outer heat exchange passage 222 and the other inner heat exchange passage 212 may be circumferentially located to correspond with the second pass of the outer heat exchange passage 222 so as to cause heat exchange between the outer heat exchange passage 222 and the inner heat exchange passages 212. In this manner, the difference in temperature across the CMC component 200 may be reduced so as to reduce thermal stress.

With reference to FIG. 2F, another embodiment of a CMC component 200 is illustrated. In this embodiment, a first cold air inlet 214 and a second cold air inlet 214 are disposed on the outer surface 220. In this example, cold air inlets 214 are disposed in a central region between support flanges 260. The first cold air inlet 214 feeds a first inner heat exchange passage 212A that extends towards a leading edge 230 of the CMC component 200 and feeds a first plurality of film cooling holes 218 that extend to the inner surface 210 of the CMC component 200.

The second cold air inlet 214 in this embodiment feeds a second inner heat exchange passage 212B that extends to a trailing edge 240 of the CMC component 200 and feeds a second plurality of film cooling holes 218 that extend to the inner surface 210 of the CMC component 200.

An advantage of this embodiment having multiple cold air inlets 214 and passages 212A and 212B is that, since the pressure on gaspath surface 210 reduces drastically from the leading edge 230 to the trailing edge 240, the pressure and amount of the cooling air fed to passage 212B can be reduced without the risk of ingesting gaspath air into the cooling passage 212B from high pressure gaspath air.

The outer heat exchange passage 222 in the embodiment of FIG. 2F includes a hot air inlet 224 disposed on a leading edge 230 of the CMC component 200 or on the inner surface 210 of the CMC component 200 so as to receive hot air from the hot gas path. In this embodiment, the outer heat exchange passage 222 extends to a hot air outlet 226 at the trailing edge 240. However, embodiments may provide the hot air outlet and cold air outlet in other locations.

While illustrated together in FIG. 2F, the concept of outer heat exchange passage 222 receiving gaspath air and the concept of multiple inner heat exchange passages 212A and 212B can be used independently in other embodiments and are not limited to use together.

For example, as illustrated in FIG. 2G, a hot gas outlet 226 of the outer heat exchange passage 222 and/or the cold gas outlet 216 of the inner heat exchange passage 212 may be disposed on the mateface 250.

With reference to FIG. 3, a flow diagram of a method 300 of reducing thermal stress in a CMC component segment forming a portion of a substantially ring-shaped stage of a gas turbine engine is disclosed, wherein the CMC component has an inner surface exposed to a hot gas path of the gas turbine engine and an outer surface on a cold non-gas path side.

The method 300 includes a step 310 of feeding a cold air flow to an inner heat exchange passage disposed adjacent the inner surface of the CMC component at a first radial distance relative to an axis of the gas turbine engine.

The method 300 also includes a step 320 of feeding a hot air flow to an outer heat exchange passage disposed adjacent the outer surface of the CMC component at a second radial distance greater than the first radial distance. Steps 310 and 320 may be performed substantially simultaneously so as to provide for heat exchange between the inner and outer heat exchange passages.

In an optional step 330, method 300 may include providing film cooling to the inner surface of the CMC component via film cooling holes in communication with the inner heat exchange passage.

In another optional step 340, the method 300 may further include feeding the hot air flow from the outer heat exchange passage to a hot air outlet disposed on the mateface and/or feeding the cold air flow of the inner heat exchange passage to a cold air outlet disposed on the mateface. Similarly, optional step 340 of the method 300 may include feeding the hot air flow from the outer heat exchange passage to a hot air outlet disposed on the trailing edge and/or feeding the cold air flow of the inner heat exchange passage to a cold air outlet disposed on the trailing edge.

In an embodiment, the step 320 of feeding the hot air flow to the outer heat exchange passage includes receiving engine gas path air at a hot air inlet of the outer heat exchange passage.

In a further embodiment, the step 310 of feeding the cold air flow to the inner heat exchange passage includes receiving cold air at a cold air inlet of the inner heat exchange passage disposed on the outer surface of the CMC component.

In various embodiments, the method 300 may include exchanging heat between the inner heat exchange passage and the outer heat exchange passage.

In additional embodiments of method 300, the CMC component may be a blade outer air seal (BOAS) segment, a vane platform segment, or a combustion liner segment.

Embodiments in accordance with the present disclosure enable cooling of inner surface of the CMC component exposed to the hot gas path material, as well as enabling cooling and/or purging of the mateface, without introducing significant thermal stress on the CMC component.

A thermal gradient of a CMC component in accordance with the present disclosure between the hot wall exposed to the gas path and the non-gas path cold wall is mitigated, by cooling hot gas path surface with lower temperature air, and warming the cold non-gas path surface with warmer air.

A thermal gradient within a CMC component in accordance with the present disclosure is further reduced by the heat exchange that occurs between the cold air in the inner heat exchange passage and the hot air in the outer heat exchange passage, similar to the function of a heat exchanger. This is beneficial also because CMC materials perform better at higher temperature, and prefer not to be overcooled, as it could be exposed to higher oxidation risks around 1000-1500F.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A ceramic matrix composite (CMC) component of a gas turbine engine forming a portion of a substantially ring-shaped gas turbine engine stage, the CMC component comprising:
an inner surface configured for exposure to a hot gas path of the gas turbine engine;
an outer surface on a non-gas path side;
an inner heat exchange passage disposed adjacent the inner surface of the CMC component at a first radial distance relative to an axis of the gas turbine engine; and
an outer heat exchange passage disposed at a second radial distance greater than the first radial distance.

2. The CMC component of claim 1, wherein the outer heat exchange passage is disposed adjacent the outer surface.

3. The CMC component of claim 1, wherein the CMC component includes a mateface transversely disposed between the inner surface and the outer surface, and
an outlet of the outer heat exchange passage and/or the inner heat exchange passage is disposed on the mateface and/or trailing edge.

4. The CMC component of claim 1, wherein a first cold air inlet and a second cold air inlet are disposed on the outer surface,
the first cold air inlet feeds a first inner heat exchange passage that extends towards a leading edge of the CMC component and feeds a first plurality of film cooling holes that extend to the inner surface of the CMC component, and
the second cold air inlet feeds a second inner heat exchange passage that extends to a trailing edge of the CMC component and feeds a second plurality of film cooling holes that extend to the inner surface of the CMC component.

5. The CMC component of claim 1, wherein a hot air inlet of the outer heat exchange passage is disposed on a leading edge of the CMC component or on the inner surface of the CMC component to receive air from the hot gas path.

6. The CMC component of claim 1, wherein the inner heat exchange passage feeds a plurality of film cooling holes disposed on the inner surface of the CMC component.

7. The CMC component of claim 1, wherein at least one of the inner heat exchange passage and the outer heat exchange passage has an exit on a trailing edge of the CMC component.

8. The CMC component of claim 1, wherein the inner heat exchange passage includes a plurality of inner heat exchange passages that each extend from a cold air inlet at a leading edge side of the outer surface to a cold air outlet at a trailing edge of the CMC component, and
the outer heat exchange passage includes a hot air inlet at a trailing edge side of the outer surface, a pass from the hot air inlet in counterflow with one of the inner heat exchange passages, a pass in parallel flow with another of the inner heat exchange passages, and a hot air outlet at the trailing edge of the CMC component.

9. The CMC component of claim 1, wherein the CMC component is a blade outer air seal (BOAS), a vane platform, or a combustion liner.

10. A ceramic matrix composite (CMC) blade outer air seal (BOAS) segment forming a portion of a substantially ring-shaped BOAS stage of a gas turbine engine, the CMC BOAS segment comprising:
an inner surface configured for exposure to a hot gas path of the gas turbine engine;
an outer surface on a non-gas path side;
an inner heat exchange passage disposed adjacent the inner surface of the CMC BOAS segment at a first radial distance relative to an axis of the gas turbine engine; and
an outer heat exchange passage disposed adjacent the outer surface of the CMC BOAS segment at a second radial distance greater than the first radial distance.

11. The CMC BOAS segment of claim 10, wherein the CMC BOAS segment includes a mateface transversely disposed between the inner surface and the outer surface, and
an outlet of the outer heat exchange passage and/or the inner heat exchange passage is disposed on the mateface.

12. The CMC BOAS segment of claim 10, wherein a hot air inlet of the outer heat exchange passage is disposed on a leading edge of the CMC BOAS segment or on the inner surface of the CMC BOAS segment to receive air from the hot gas path,
the inner heat exchange passage feeds a plurality of film cooling holes disposed on the inner surface of the CMC BOAS segment, and
at least one of the inner heat exchange passage and the outer heat exchange passage has an exit on a trailing edge of the CMC BOAS segment.

13. The CMC BOAS segment of claim 10, wherein a first cold air inlet and a second cold air inlet are disposed on the outer surface between support flanges of the CMC BOAS segment,
the first cold air inlet feeds a first inner heat exchange passage that extends towards a leading edge of the CMC BOAS segment and feeds a first plurality of film cooling holes that extend to the inner surface of the CMC BOAS segment, and
the second cold air inlet feeds a second inner heat exchange passage that extends to a trailing edge of the CMC BOAS segment and feeds a second plurality of film cooling holes that extend to the inner surface of the CMC BOAS segment.

14. A method of reducing thermal stress in a ceramic matrix composite (CMC) component segment forming a portion of a substantially ring-shaped stage of a gas turbine engine, wherein the CMC component has an inner surface exposed to a hot gas path of the gas turbine engine and an outer surface on a cold non-gas path side, the method comprising:
feeding a cold air flow to an inner heat exchange passage disposed adjacent the inner surface of the CMC component at a first radial distance relative to an axis of the gas turbine engine; and
feeding a hot air flow to an outer heat exchange passage disposed adjacent the outer surface of the CMC component at a second radial distance greater than the first radial distance.

15. The method of claim 14, further comprising feeding the hot air flow and/or the cold air flow to a respective outlet of the outer heat exchange passage and/or the inner heat exchange passage disposed on the mateface.

16. The method of claim 14, wherein feeding the hot air flow to the outer heat exchange passage includes receiving engine gas path air at a hot air inlet of the outer heat exchange passage.

17. The method of claim 16, wherein feeding the cold air flow to the inner heat exchange passage includes receiving cold air at a cold air inlet of the inner heat exchange passage disposed on the outer surface of the CMC component.

18. The method of claim 17, further comprising providing film cooling to the inner surface of the CMC component via film cooling holes in communication with the inner heat exchange passage.

19. The method of claim 14, further comprising exchanging heat between the inner heat exchange passage and the outer heat exchange passage.

20. The method of claim 14, wherein the CMC component is a blade outer air seal (BOAS) segment, a vane platform segment, or a combustion liner segment.
